(19) United States
(12) Patent Application Publication
(10) Pub. No.: US 2017/0193599 A1
(43) Pub. Date: Jul. 6, 2017

(54) SYSTEMS AND METHODS FOR DETERMINING CREDITWORTHINESS OF A POTENTIAL BORROWER BASED ON INCOMING INTERNATIONAL CALLING DATA

(71) Applicant: Viva Bahrain B.S.C., Manama (BH)

(72) Inventor: Karim Tabbouche, Manama (BH)

(21) Appl. No.: 14/987,472

(22) Filed: Jan. 4, 2016

(51) Int. Cl. G06Q 40/02; H04M 15/00

(52) U.S. Cl. CPC G06Q 40/025; H04M 15/44

(57) ABSTRACT

Systems, devices, and methods are disclosed for determining creditworthiness of a user of a communication device using call data from a telecommunications service provider. The system may include a communication device associated with a potential borrower. A first server may be associated with a service provider and may comprise a provider database including call data associated with the communication device. A second server may be associated with a lender and may include communication elements configured to establish a communication channel with the first server and receive at least the call data. The second server may also include a processor configured to determine a credit score of the potential borrower based on at least an amount of money spent by an international caller to speak with the potential borrower.

### TECHNICAL FIELD

The application relates generally to systems and methods for determining a credit score of a potential borrower. More particularly, the disclosure relates to methods and systems for determining a credit score of a user of potential borrower based at least in part on an amount spent by an international caller to speak with the potential borrower.

### BACKGROUND

Before lending money to a potential borrower, a lender may desire to estimate a likelihood that the potential borrower will repay his or her debt. Conventionally, lenders may lend money to a potential borrower based largely on a credit score indicating the creditworthiness of the potential borrower. Conventional credit scores are typically determined based on different factors, such as current debt, length of a credit history, a debt payment history, different types of credit that the borrower currently has, and other items from a credit report.

In many developing countries or regions, conventional credit scoring methods may be unavailable. For example, potential borrowers in such regions may not have access to conventional banks and lending institutions and may lack a financial history for determination of a credit score. However, many of such individuals seek some type of financing (e.g., microfinancing). Even though determining a credit score of the potential borrower (and therefore, a risk associated with lending money to the potential borrower) may be difficult, many institutions may desire to extend credit to qualified individuals. Alternative credit scoring methods have been investigated, including deriving a credit history based on the potential borrower's Internet browsing behavior.

### BRIEF SUMMARY

Embodiments of the disclosure include systems and methods for determining a creditworthiness of a potential borrower. For example, in accordance with one embodiment of the disclosure, a method of determining a creditworthiness of a potential borrower comprises receiving call data including incoming international calls received from an international caller to a potential borrower, wherein the potential borrower is determined to specifically rely upon the international caller for at least a portion of the potential borrower's income, determining, by a processor, a financial strength of the international caller based, at least in part, on analyzing an amount spent for international calls from the call data, determining, by the processor, a relationship strength between the international caller and the potential borrower, and determining, by the processor, creditworthiness of the potential borrower based, at least in part, on the determined financial strength of the international caller, and the determined relationship strength between the international caller and the potential borrower.

In other embodiments, a system for determining creditworthiness of a potential borrower who is a user of a communication device comprises a communication device associated with a potential borrower or an international caller who is a customer of a telecommunications service provider, and a first server associated with at least one of the telecommunications service provider or a lender. The first server comprising a first database including call data associated with the communication device from the telecommunications service provider, and a processor configured to determine creditworthiness of the potential borrower based on at least an amount of money spent by the international caller to communicate with the potential borrower based on an analysis of the call data, wherein the potential borrower is verified to be at least partially financially dependent on the international caller.

In yet other embodiments, a server associated with a lender and configured to determine a credit score of a potential borrower comprises communication elements configured to communicate with a provider server associated with a telecommunications service provider, a lender database stored in memory and configured to store at least one of call data or financial information received for the potential borrower from the provider server, and a processor operably coupled with the memory. The processor is configured to determine an amount spent by an international caller to communicate with the potential borrower based on incoming international calls to the potential borrower and an international call rate for the international caller; and determine creditworthiness of the potential borrower based on the amount spent by the international caller over a predetermined period of time.

### BRIEF DESCRIPTION OF THE SEVERAL VIEWS OF THE DRAWINGS

FIG. 1 is a simplified block diagram of a system configured to facilitate acquisition and transmission of communication device call data between a service provider and a lender according to an embodiment of the disclosure;

FIG. 2 is a simplified schematic block diagram of a service provider server according to an embodiment of the disclosure;

FIG. 3 is a simplified schematic block diagram of a lender server according to an embodiment of the disclosure;

FIG. 4 is a flowchart illustrating a method of determining whether to extend credit to a potential borrower according to an embodiment of the disclosure;

FIG. 5 is a flowchart illustrating a method of determining a credit score of a potential borrower according to an embodiment of the disclosure; and

FIG. 6 is a simplified block diagram of a system configured to determine a credit score of a potential borrower according to an embodiment of the disclosure.

### DETAILED DESCRIPTION

In the following detailed description, reference is made to the accompanying drawings which form a part hereof, and in which is illustrated specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions, rearrangements, or combinations thereof within the scope of the disclosure may be made and will become apparent to those of ordinary skill in the art.

In accordance with common practice, the various features illustrated in the drawings may not be drawn to scale. The illustrations presented herein are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus or all operations of a particular method. In addition, like reference numerals may be used to denote like features throughout the specification and figures.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the disclosure may be implemented on any number of data signals including a single data signal.

The various illustrative logical blocks, modules, circuits, and algorithm acts described in connection with embodiments disclosed herein may be implemented or performed with a processor, such as a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perforin the functions described herein. A processor herein may be any processor, controller, microcontroller, or state machine suitable for carrying out processes of the disclosure. A processor may also be implemented as a combination of computing devices, such as a combination of a DSP and a microprocessor, a plurality of microprocessors, one or more microprocessors in conjunction with a DSP core, or any other such configuration. When configured according to embodiments of the disclosure, a special-purpose computer improves the function of a general-purpose computer because, absent the disclosure, the general-purpose computer would not be able to carry out the processes of the disclosure.

The disclosure also provides meaningful limitations in one or more particular technical environments that go beyond an abstract idea. For example, embodiments of the disclosure provide improvements in the field of microfinance, estimation of a credit score of a potential borrower based on an amount spent by an international caller to speak with the potential borrower, methods of determining a credit score of a potential borrower for whom conventional credit information is lacking, and other related fields. In particular, embodiments may improve estimation of a potential borrower's ability to repay a loan, which in turn may result in improving the borrowing default rate. Other embodiments include systems and methods of determining a credit score of a potential borrower based on an amount spent by at least one international caller to call the potential borrower, a consistency of such calls from the at least one international caller, and a change in an amount spent by the international caller relative to changes in an international call rate.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, interfacing with an operating system, etc. Furthermore, the methods disclosed herein may be implemented in hardware, software, or both. If implemented in software, the functions may be stored or transmitted as one or more instructions (e.g., software code) on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

As used herein, a potential borrower may be a person seeking an extension of credit (e.g., a loan, a microloan, etc.) from a lender, which may include a bank, or non-traditional financial services companies such as Western Union. In some embodiments, a potential borrower is a person for whom using conventional credit scoring methods (e.g., such as those available from Experian, Equifax, TransUnion, FICO, Innovas, etc.) to determine creditworthiness may not be available. For example, the potential borrower may not have a savings account, a checking account, or any other type of financial account at a bank. In some situations, the potential borrower may be dependent upon another party for a remittance of money, such as a monthly remittance, as a primary source of income.

As used herein, a “call” includes various types of communication between two parties, including for example, a voice call and/or a message (e.g., SMS). Thus, the charge for a call may be based on a duration and a call rate for calls having a particular duration, while the charge for a call may be based on a price per message or size of message (e.g., data used, message length, etc.) for calls that do not have a particular duration.

The potential borrower may seek a loan (e.g., a microloan) from a lender. However, the lender may lack adequate information related to the potential borrower to determine the advisability of lending money to the potential borrower. According to embodiments described herein, a credit score (e.g., an indicator of creditworthiness) of a potential borrower may be determined based on call information associated with a communication device of the potential borrower. A service provider may collect and store call information related to the communication device associated with the potential borrower including, for example, user profile information, incoming and outgoing call data (e.g., date of calls to and from the communication device, origin of incoming calls, destination of outbound calls, duration of calls, call rates, message data, etc.). A situation in which this may occur is when the international caller is an expatriate who is living abroad, while their family is living in their home country and is partially dependent on receiving income sent from the working expatriate. In such a situation, the family member (the potential borrower) of the expatriate worker (international caller) may desire a loan from a lender, who may desire to determine the creditworthiness of the family member (potential borrower) using the family member's (potential borrower's) call data to determine the amount of money spent by the expatriate worker (international caller) in such international calls. Such methods and systems may be beneficial in instances where conventional methods of determining a credit score of the family member (potential borrower) are unavailable, such as when the family member (potential borrower) is unbanked or resides in a location where conventional loans are unavailable. This is contrast to conventional alternative methods for determining creditworthiness that are primarily focused on the borrower's direct capacity. Embodiments of the present disclosure derive creditworthiness of the borrower based on incoming international call patterns of a financially supporting remitting party (the international caller).

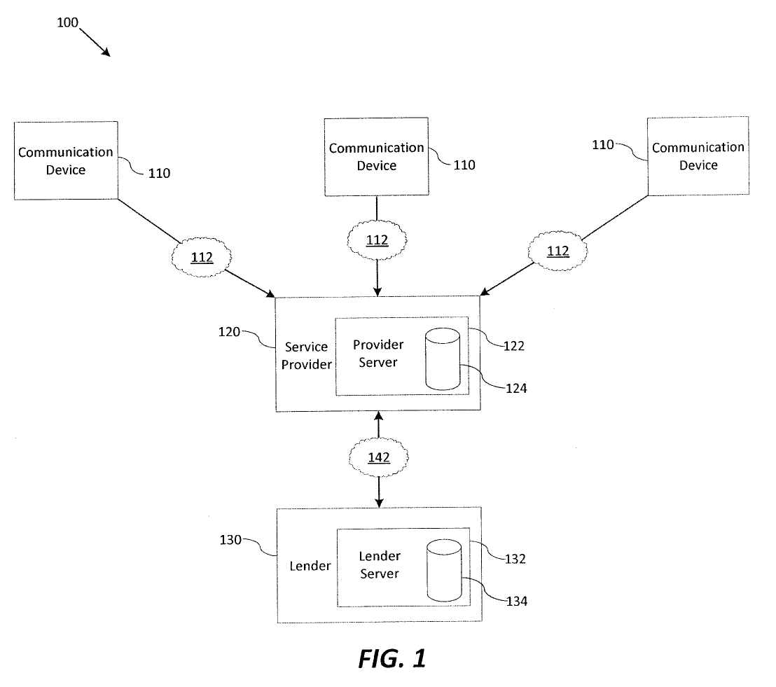

FIG. 1 is a simplified block diagram of a credit scoring and lending system 100 configured to assist in the decision making process of determining creditworthiness and possibly providing a loan to an potential borrower. In particular, the system 100 may include one or more communication devices 110, a telecommunications service provider 120 (also referred to as “service provider”), and a lender 130.

The service provider 120 may facilitate (e.g., establish) communication sessions (i.e., calls) between communication devices 110. The calls may include calls using a variety of different networks and protocols, such as PSTN, IP-based networks (e.g., VoIP), cellular networks, and combinations thereof. Thus, the service provider 120 may be configured to facilitate calls for a variety of different networks and protocols. Likewise, the communication devices 110 may include different types of devices, such as mobile devices (e.g., smart phone), landline phones, a VoIP phones, etc. Of course, it should be understood that although FIG. 1 illustrates only three communication devices 110, the system 100 may include more communication devices associated with other communication device users. It is contemplated that the system 100 may facilitate calls and other data transmission between the service provider 120 and any number and combination of communication devices 110.

Also, the term “network” as used herein includes networks that are compatible and configured to provide communications using analog and/or digital standards unless specifically stated otherwise. In some embodiments, the network may refer to a cellular network. Although FIG. 1 illustrates each of the first network 112 and the second network 142 as different networks, in some embodiments, each of the first network 112 and the second network 142 may be the same network (e.g., both connections may be Internet-based connections). Thus, discussion of the first network 112 and the second network 142 may be for convenience of discussing a particular connection between a plurality of communication devices 110 and the service provider 120, or between the service provider 120 and the lender 130. In other embodiments, each of the first network 112 and the second network 142 may comprise a different network.

With continued reference to FIG. 1, the service provider 120 may include a provider server 122 including a provider database 124. The service provider 120 may facilitate communication sessions for users of communication devices 110. In some embodiments, the service provider 120 establish communication sessions between one or more communication devices 110 and at least another communication device, which may include a mobile device (e.g., smart phone), a landline phone, a VoIP phone, etc. Accordingly, the service provider 120 may facilitate a communication session between a user of a communication device 110 with at least another individual. In some embodiments, the service provider 120 facilitates communication between a communication device 110 and a communication device located internationally. By way of non-limiting example, the service provider 120 may facilitate a communication session between a user of a communication device 110 and an international caller.

The service provider 120 may also be configured to monitor and/or receive call data associated with calls involving the communication devices 110 of its customers. Call data may include incoming calls, outgoing calls, the call type (e.g., voice, SMS, data, Voice Over IP, Video Chat, wireless application protocol (WAP)), call duration, the phone numbers or other identifiers involved in the calls, such as the origin of incoming calls (e.g., country of origin) or destination of outgoing calls (e.g., country of destination), etc. The country of origin/destination of the call may be based on a country code (typically designated by +XXX) or other identifier used for the other party involved in the call. The call data for each customer may be stored in the provider database 124. The call data may be organized or accessible in the provider database 124 by individual call or as aggregated call data. The aggregated call data may be organized by other common factors (e.g., calls to/from a particular number, calls to/from a particular country or region, calls to/from a particular organization, etc.).

The provider database 124 may also store user account information associated with each communication device 110. User account information may include information such as a user name, a phone number associated with the user name, the user's date of birth, age, gender, address, email address, governmental identification (e.g., social security number, individual taxpayer identification number (ITIN)), or any other identifying information. For each customer of the service provider 120 (i.e., each user associated with a communication device 110), the provider database 124 may store user account information linked with the call data of the particular communication device 110.

In some embodiments, the provider database 124 may be configured to store financial information associated with each communication device 110. Financial information may include one or more of a cost of incoming calls (e.g., a cost of incoming domestic calls, a cost of incoming international calls, etc.), a cost of outgoing calls (e.g., a cost of outgoing domestic calls, a cost of outgoing international calls, etc.), and a call rate associated with incoming and outgoing international calls. In some embodiments, a cost of incoming calls may be attributed to a caller associated with the incoming call, and a cost thereof may be determined by multiplying a call rate applicable to the incoming call (i.e., a call rate applicable at the origin of the call) by the duration of the call. By way of non-limiting example, a cost of an incoming international telephone call may be determined by the service provider 120 by multiplying an international rate applicable to the caller placing the international call by a duration of the incoming international call. Accordingly, in some embodiments, even though an incoming call may not be charged to an account of a user of a communication device 110, the financial information may include a cost charged to a person calling the communication device 110.

The service provider 120 may communicate with a lender 130 over the second network 142. In particular, the provider server 122 may transmit data from the provider database 124 to the lender server 132 for the lender server 132 to determine the creditworthiness of a potential borrower who is also a customer of the service provider 120. The provider server 122 may transmit one or more of the user account data, the call data, and the financial data as discussed above. The lender server 132 may receive such data and store the data in a lender database 134.

As an example, a potential borrower may seek financing (e.g., microfinancing) from the lender 130. As discussed above, a conventional credit score may be unavailable for the potential borrower due to a lack of credit history, financial accounts, or other reasons. The potential borrower may provide the lender 130 with information such as the potential borrower's name, date of birth, age, gender, address, phone number, email address, governmental number (e.g., social security number, individual taxpayer identification number), or other unique identifying information.

The lender server 132 may transmit a request to the service provider 120 to determine whether the service provider 120 has information related to the user account for the communication device of the potential borrower. The request from the lender server 132 may include at least some of the information provided by the potential borrower to the lender 130. For example, the lender server 132 may transmit one or more of the potential borrower's phone number, name, date of birth, age, gender, address, email address, governmental identification (e.g., social security number, individual taxpayer identification number), or unique identifying information.

Responsive to receiving the request from the lender server 132, the provider server 122 may query its records (e.g., the provider database 124) to determine whether the potential borrower has a user account with the service provider 120 based on the information provided by the lender server 132 about the potential borrower. By way of non-limiting example, responsive to receiving a request form the lender server 132, the service provider 120 may query the provider database 124 for user accounts that match a particular phone number, user name, date of birth, age, gender, address, email address, social security number, individual taxpayer identification number, other identification number or unique identifying information.

If a user account matches the borrower information, the service provider 120 may transmit the relevant information linked to the user account that matches the borrower information. For example, the service provider 120 may transmit one or more of the user account information, the call data, and the financial information to the lender 130. Thus, the provider server 122 may transmit to the lender server 132 one or more of a number of incoming calls, number of outgoing calls, type of call (voice, SMS, data, wireless application protocol (WAP)), incoming calls, outgoing calls, origin of incoming calls (e.g., country of origin, whether the incoming calls are international or local, etc.), destination of outgoing calls, geographical reach of incoming and outgoing calls, call rates associated with incoming calls, call rates associated with outgoing calls, data usage, duration of calls, incoming call volume, outgoing call volume, number of unique incoming calls (e.g., number of unique incoming call numbers), number of unique outgoing calls (e.g., number of unique outgoing call numbers), average duration of incoming calls, average duration of outgoing calls, average duration of incoming international calls, average duration of incoming international calls from a particular caller or from a particular country, messages sent (e.g., SMS), or information that may be associated with the communication device of the matching profile. In some embodiments, the call data may be comprehensive to all calls associated with the customer, whereas in other embodiments, the call data transmitted to the lender may only be the call data associated with the international caller that is being used as the basis for determining the creditworthiness of the potential borrower. In some embodiments, the call data may be the call data for the potential borrower's customer account, whereas in other embodiments, the call data may be the call data for the international caller's customer account. Thus, one or both of the potential borrower and the international caller may be customers of the service provider 120. In other words, the service provider 120 may have access to (and analyze as discussed below) the call data for the international caller, the potential borrower, or both parties.

In some embodiments, the lender 130 may be configured determine the financial information and the creditworthiness of the potential borrower based on the information provided by the service provider 120. By way of non-limiting example, the lender 130 may be configured to determine a cost associated with incoming international calls to the potential borrower's communication device. The cost may be determined by multiplying an international call rate by a duration of each incoming call to the potential borrower for duration-based calls. The cost may be determined by multiplying an international call rate by a number of messages sent for non-duration based calls such as SMS messages. The international call rate may be provided to the lender 130 by the service provider 120 or may be determined by the lender 130 based on a date and an origin of the incoming call. In some embodiments, the international call rate is a posted international call rate by the communication service provider of the international caller placing the international call.

The lender 130 may be configured to determine a frequency (e.g., daily, biweekly, weekly, bimonthly, monthly, etc.) at which one or more international callers calls the potential borrower. The lender 130 may further be configured to determine, based on the information provided by the service provider 120, a strength of a relationship between the potential borrower and one or more international callers who call the potential borrower. The strength of the relationship may depend, at least in part, on a frequency of calls from the international caller to the potential borrower and a duration of such calls.

The lender 130 may further be configured to determine an elasticity of international calls from one or more international callers to the potential borrower. As used herein, an elasticity means and includes a relative change in incoming international call patterns (e.g., duration) relative to a change in the international call rate. In other words, the elasticity may be defined as:

(R₁/R₂)/(D₂/D₁) (1),

wherein R₁ and R₂ are the international call rates at a first time and a second time, respectively, D₁ is a duration of incoming international calls to the potential borrower while the international rate is equal to R₁, and D₂ is a duration of incoming international calls to the potential borrower while the international rate is equal to R₂. For non-duration based communications (e.g., SMS messages), the elasticity may be defined as:

(R₁/R₂)/(M₂/M₁) (2),

wherein M₂ and M₁ are the number of messages sent by the international caller for each corresponding message rate R₁ and R₂. In some embodiments, a combined elasticity of both voice calls and text messages may also be determined from the call data.

In general, an elasticity that remains close to unity (i.e., 1.0) after a change in an international call rate means that an international caller spends about the same amount of money (i.e., a duration of such calls reflects changes in the international call rate) calling the potential borrower regardless of the international call rate. On the other hand, an elasticity that deviates from unity may mean that an amount of money spent by the international caller to call the potential borrower is less dependent on the international call rate. An elasticity equal to unity may be an indication that the international caller has less disposable income (and a lower financial strength) than an elasticity that deviates from unity.

Although the lender 130 has been described as determining the financial information, in yet other embodiments, the service provider 120 may be configured to determine the financial information and may transmit the financial information to the lender 130. The financial information may include a cost of incoming international calls to the potential borrower (i.e., an amount spent by international callers to call the potential borrower). In some embodiments, the service provider 120 transmits financial information for each international call placed to the potential borrower to the lender 130. The service provider 120 may transmit the information for each unique telephone number that places an international call to the potential borrower, including a frequency of the international calls from each international caller, a duration of each call, an amount spent for each call, a frequency of such calls, and an elasticity of calls from an international caller. The information may further include an amount spent by the international caller to speak with the potential borrower for a given period of time (over the course of a day, a week, two weeks, a month, etc.). In some embodiments, the information includes an amount spent by the international caller each month for a period of several months (e.g., two, three, four, etc.).

In other embodiments, the service provider 120 may transmit only the financial information (including one or more of an amount spent by each international caller to call the potential borrower, a duration of each call, and a date of each call) and the lender 130 may be configured to determine one or more of a frequency and elasticity of such calls. Accordingly, based on the information transmitted from the service provider 120, the lender 130 may determine how much an international caller spends to speak with the potential borrower, a frequency of such international calls from a particular international caller to the potential borrower, a strength of a relationship between the international caller and the potential borrower, and an elasticity of the international calls to the potential borrower. As will be described herein, such information may be correlated to a credit score of the potential borrower and may aid the lender 130 in determining whether to extend credit to the potential borrower.

In some embodiments, creditworthiness of the potential borrower may be further influenced by the labor laws of the country in which the second party (i.e., the international caller) resides. The labor laws of the second party country may include, for example, whether employment in the country is at will or whether the labor laws require contractual employment. If the labor laws require contractual employment, the term of the second party's employment contract (e.g., one year, two years, etc.) may be required for assessing the creditworthiness of the potential borrower. Operation 522 may further include determining whether the second party is beyond a probationary employment period. In some embodiments, the credit score of the potential borrower may increase when the second party is beyond the probationary period. The second party country may be determined using the received caller ID of the respective country code. As such the service provider will track and identify as soon as the first call is made from a new country, which could indicate that the calling party (the international caller) has established residence and sought new employment in a new country. In some embodiments, the maximum loan term permitted by the system to be offered by the lender may only post the probationary period or be limited to the length remaining term of the contract.

In some embodiments, the lender 130 may purchase the data from the service provider 120 for all customers of the service provider 120 or at least all customers meeting desired criteria for the lender 120 (e.g., within a certain geographical region) such that the lender database 134 is periodically provided with updated customer data (e.g., call data), certain user account data, etc. From this information, the lender 130 may query its own lender database 134 to determine if the information provided by the potential borrower matches any of the information received from the service provider 120 rather than sending an individual request to the service provider 120 each time a potential borrower requests a loan. In addition, such information may also be useful and valuable for the lender 130 to generate sales leads by contacting (e.g., sending targeted advertisements) individuals who may be pre-qualified for a loan of a certain monetary value based upon the information periodically updated by the service provider 120. As a result, the service providers may receive additional revenue by selling such data to lenders.

In an alternative embodiment, the analysis and calculations of the call data may be performed by the service provider 120 such that the specific call data and other information may not need to be transmitted to the lender 130. In such an embodiment, the lender 130 may send a request to the service provider 120 to receive information regarding the creditworthiness of a potential borrower who may also be a customer of the service provider 120. The service provider 120 may retrieve and analyze the call data to determine a credit score for the potential borrower based, at least in part, on the amount of money spent by the international caller. The service provider 120 may simply send the lender 130 the score calculated by the service provider 120 rather than sending call data and other customer data to the lender 130. The service provider 120 may still receive additional revenue from the calculation and transmittal of a credit score.

In some embodiments, the service provider 120 and the lender 130 may be the same entity. In other words, the service provider 120 may use its own data to extend its own customers a line of credit for various purposes, including permitting customers to borrow funds for using telecommunication services of the service provider. It is contemplated that the customer may be permitted to have an overdue balance for a longer period of time before discontinuing services. In some embodiments, the creditworthiness determination may be used by the service provider to determine whether to offer services that could entail some financial liability to the service provider in case of default (e.g., handset subsidy). A positive determination of creditworthiness may enable the customer to have a negative balance up to a certain threshold for a pre-paid phone or data plan.

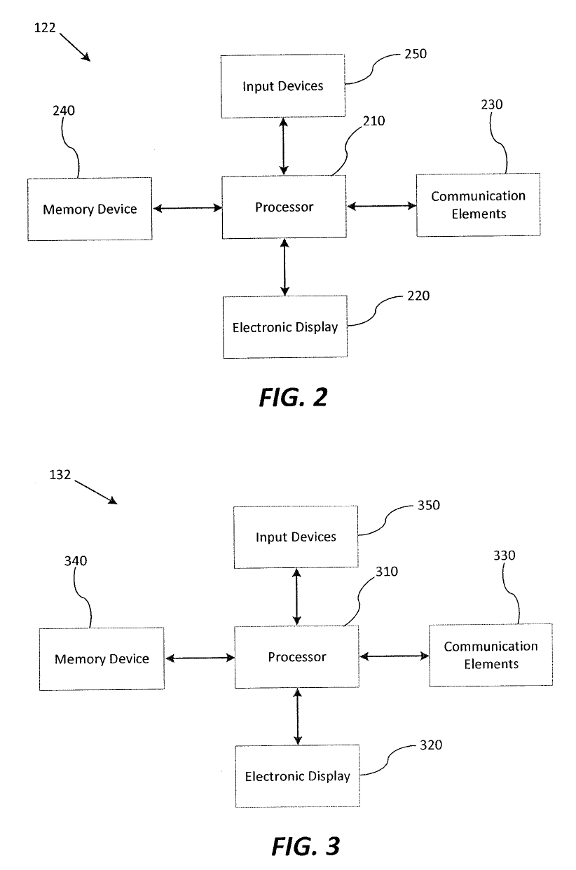

FIG. 2 is a simplified schematic block diagram of the provider server 122 of the service provider 120 (FIG. 1) according to an embodiment of the disclosure. The provider server 122 may be configured to establish communication with a plurality of communication devices 110 (FIG. 1) associated with different users (i.e., customers) of the service provider 120. The provider server 122 may further be configured to establish communication with the lender server 132 of the lender 130 (FIG. 1) for embodiments in which customer data (e.g., call data, user account data, financial data, credit score, etc.) may be transmitted from the provider server 122 to the lender server 132 in response to a request for a loan by a potential borrower.

The provider server 122 may include a processor 210 operably coupled with an electronic display 220, communication elements 230, a memory device 240, and input devices 250. The processor 210 may coordinate the communication between the various devices as well as execute instructions stored in computer-readable media of the memory device 240. The processor 210 may be configured to execute a wide variety of operating systems and applications including the computing instructions. The memory device 240 may be used to hold computing instructions, data, and other information for performing a wide variety of tasks including performing embodiments disclosed herein. By way of example and not limitation, the memory device 240 may include Synchronous Random Access Memory (SRAM), Dynamic RAM (DRAM), Read-Only Memory (ROM), Flash memory, and the like. The memory device 240 may include volatile and non-volatile memory storage for the provider server 122. The memory device 240 may include the provider database 124 (FIG. 1).

The communication elements 230 may be configured for communicating with other devices or communication networks, including communication devices or the lender 130 (FIG. 1). As non-limiting examples, the communication elements 230 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1a/b/g/n type wireless connections, and other suitable communication interfaces and protocols. The input devices 250 may include a numeric keypad, a keyboard, a touchscreen, a remote control, a mouse, other input devices, or combinations thereof.

The processor 210 may also be configured to query with the provider database 124 and to manipulate the data therein to determine, for each customer phone number associated with the service provider 120 (FIG. 1), one or more of call data, financial information, an international call rate applicable to each international caller calling the communication device, an amount of money spent by each international caller to call the communication device, a call frequency from one or more international callers to the communication device, an elasticity of international calls to the communication device from each international caller, a strength of a relationship between the user of the communication device and the international caller, and a credit score for each customer using the above information.

FIG. 3 is a simplified schematic block diagram of the lender server 132 of the lender 130 (FIG. 1) according to an embodiment of the disclosure. The lender server 132 may be configured to establish communication with the provider server 122 of the service provider 120 (FIG. 1).

The lender server 132 may include a processor 310 operably coupled with an electronic display 320, communication elements 330, a memory device 340, and input devices 350. The processor 310 may coordinate the communication between the various devices as well as execute instructions stored in computer-readable media of the memory device 340. The processor 310 may be configured to execute a wide variety of operating systems and applications including the computing instructions. The memory device 340 may be used to hold computing instructions, data, and other information for performing a wide variety of tasks including performing embodiments disclosed herein. By way of example and not limitation, the memory device 340 may include Synchronous Random Access Memory (SRAM), Dynamic RAM (DRAM), Read-Only Memory (ROM), Flash memory, and the like. The memory device 340 may include volatile and non-volatile memory storage for the lender server 132. The memory device 340 may include the lender database 134 (FIG. 1).

The communication elements 330 may be configured for communicating with communication elements 230 (FIG. 2) of the service provider 120. The communication elements 230 may be configured to establish communication channels between the lender 130 and the service provider 120 to facilitate transmission of the user account information, call data, financial information, and any other information processed by the processor 210 based on such information (e.g., call frequency, amount spent by international caller to call communication device, international call rates associated with such international calls, an elasticity of such international calls, and a strength of a relationship between the user of the communication device and the international caller), or other information related to one or more communication devices associated with the potential borrower. As non-limiting examples, the communication elements 330 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1a/b/g/n type wireless connections, and other suitable communication interfaces and protocols. The input devices 250 may include a numeric keypad, a keyboard, a touchscreen, a remote control, a mouse, other input devices, or combinations thereof.

The processor 310 may be configured to query the lender database 134 and manipulate the data therein to determine, for the potential borrower, one or more of financial information, a call frequency from one or more international callers to the mobile user device (which may be, for example, a potential borrower), an international call rate applicable to each international call to the communication device, an amount of money spent by each international caller to call the communication device, an elasticity of international calls to the mobile number from each international caller, and a strength of the relationship between the potential borrower and the international caller. As described herein, such information may be used by the processor 310 to determine a credit score of the potential borrower and, ultimately, to determine whether or not to extend credit to the potential borrower.

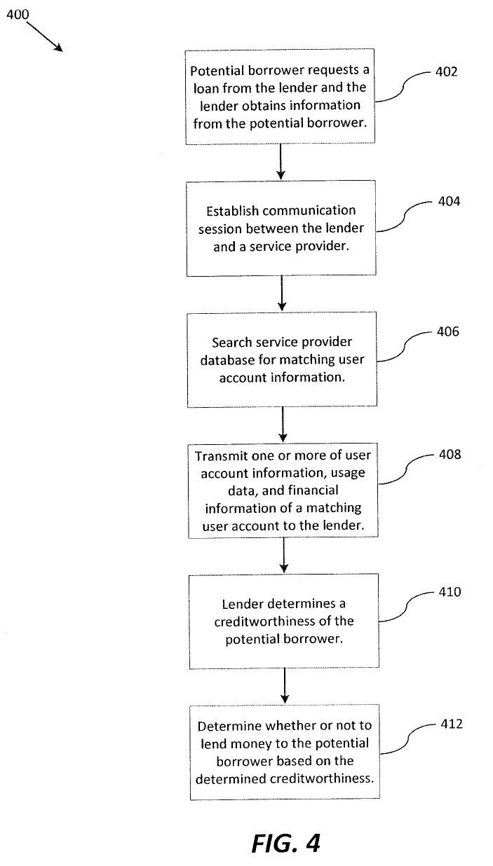

FIG. 4 is a flowchart 400 illustrating a method of determining creditworthiness for a potential borrower according to an embodiment of the disclosure. At operation 402, a potential borrower seeks financing from a lender and the lender may obtain information about the potential borrower. The information obtained by the lender may include, for example, a desired loan amount as well as identifying information of the potential borrower. Such identifying information may include the potential borrower's name, date of birth, age, gender, address, phone number, email address, government identification (e.g., social security number, individual taxpayer identification number, etc.), or other unique identifying information.

At operation 404, communication between the lender and a telecommunications service provider may be established. The lender may request information related to the communication device associated with the potential borrower from the service provider. The lender may provide the service provider with at least some of the information provided to the lender from the potential borrower at operation 402. For example, the lender may provide the service provider with at least a phone number associated with the potential borrower and/or the potential borrower's name. In some embodiments, the lender may provide the service provider with a date of birth, age, gender, address, email address, government identification (e.g., social security number, individual taxpayer identification number, etc.) or other unique identifying information of the potential borrower to assist with the verification of the potential borrower within the service provider's customer database.

At operation 406, the service provider queries its customer database (e.g., the provider database for a user account that matches the information provided to the service provider by the lender at operation 404. For example, the processor of the provider server may query the provider database for a phone number matching the phone number provided by the lender. In addition, the provider database may be queried for one or more of a matching name, address, or other identifying information. Where the provider database includes a matching number and other matching information, the information in the processor links the information in the provider database to the request from the lender to form a matching profile.

At operation 408, the service provider transmits at least some of the information associated with the matching profile to the lender. As described above, the information transmitted from the service provider to the lender may include user account information, call data, financial information, a credit score, or a combination thereof. By way of nonlimiting example, the service provider may transmit one or more of a number of incoming international telephone calls to the mobile number, a duration of incoming international telephone calls, international call rates associated with incoming international calls, number of incoming international telephone calls, average duration of incoming international telephone calls, a cost associated with incoming international calls, and telephone numbers associated with each of the above. In some embodiments, the service provider transmit only a cost of international telephone calls incoming to the phone number associated with the potential borrower, a duration of such calls, and a time and date of such calls. In yet other embodiments, the service provider may transmit how much an international caller spends to speak with the potential borrower, a frequency of such international calls from a particular international caller to the potential borrower, a strength of a relationship between the international caller and the potential borrower, and an elasticity of the international calls to the potential borrower based on changing international call rates. The information may be stored within the lender database.

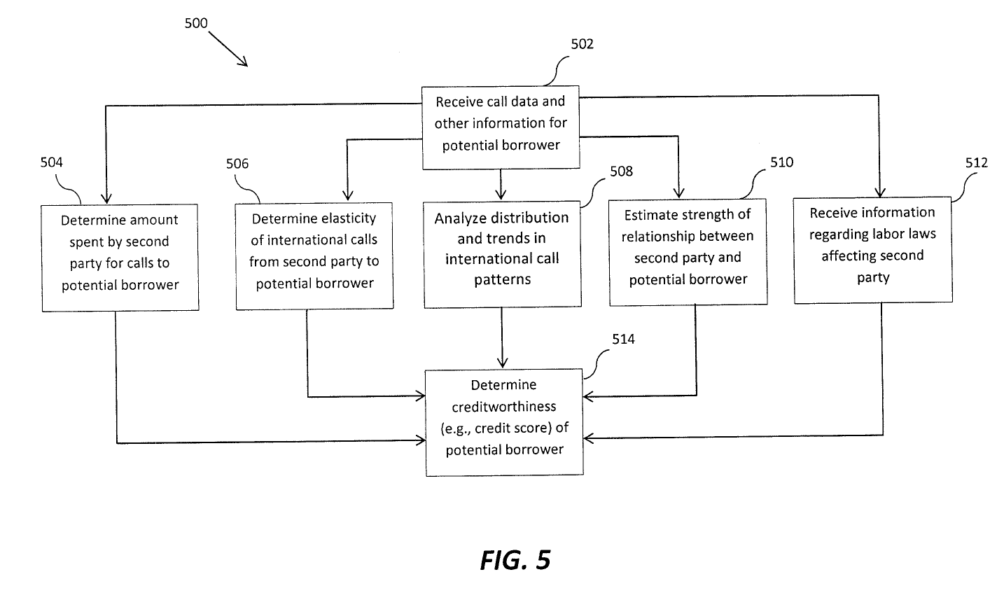

At operation 410, the lender receives the information transmitted by the service provider at operation 408 and calculates a credit score of the potential borrower based on at least some of the information provided by the service provider. The credit score may be based on one or more additional factors derived from the information in the lender database, as will be described below with reference to FIG. 5. In some embodiments, the credit score or other measure of creditworthiness may be determined by the service provider and transmitted to the lender. As a result, the call data and other financial data may not necessarily be transmitted to third parties, and a proprietary credit score may be transmitted instead without the underlying data used to determine the credit score.

At operation 412, the lender may determine whether or not to extend credit to the potential borrower based on the calculated credit score of the potential borrower. In some embodiments, the lender may lend money to the potential borrower where the calculated credit score exceeds a threshold value. In other embodiments, the decision to extend credit may depend on both, an amount of the loan and the calculated credit score of the potential borrower.

FIG. 5 is a flowchart 500 illustrating a method of determining creditworthiness of the potential borrower, according to an embodiment of the disclosure. With reference to FIG. 4, this method may be performed at operation 410. As discussed above, one or more steps of this process may be performed by the lender in response to receiving call data and other related information from a service provider for a potential borrower who is also a customer of the service provider. In some embodiments, one or more steps of this process may be performed by the service provider in response to receiving a request for a credit score using its call data and other related information for a potential borrower who is also a customer of the service provider.

The method includes determining, among other things, credit score based at least on part on an amount an international caller spends to speak with a potential borrower. The second party may be a family member, a friend, or an acquaintance of the potential borrower. In some embodiments, the potential borrower may depend on the second party for a portion of the potential borrower's monthly income. In other words, the second party may transfer a remittance (e.g., a monthly remittance) to the potential borrower and the remittance may constitute at least a portion of the potential borrower's income.

For purposes of the flowchart 500 of FIG. 5, it is assumed that the potential borrower has been verified as a customer of the service provider such that call data and other related data may be available for the potential borrower with respect to incoming international calls with the second party that the credit score will be based upon. At operation 502, the call data and other information may be received for the potential borrower. The system may detect a first call of the international caller originating in a new country, which may indicate that a new residence has been established for the international caller. Operations 504 through 512 indicate different operations that may be performed on the call data and other information that may be used as factors for determining the creditworthiness of the potential borrower.

At operation 504, an amount spent by the second party for international calls (e.g., all international calls, calls to the borrower, etc.) may be determined. In some embodiments, the amount spent by the second party may be based on analyzing the potential borrower's call data. In such an embodiment, the amount spent may be based primarily (e.g., exclusively) on the amount spent by the second party to communicate with the potential borrower as the second party's calls to other parties may not be available. In some embodiments, the amount spent by the second party may be based on analyzing the second party's call data. In such an embodiment, the second party's calls to other parties may be available for analysis such that the total amount spent by the second party on all calls (e.g., international calls, domestic calls, or a combination thereof) may be used to determine the financial strength of the second party for purposes of determining the creditworthiness of the potential borrower.

As an example, a number and duration for incoming international calls to the potential borrower from the second party over a predetermined period of time may be analyzed. The predetermined period of time may be, for example, one week, two weeks, one month, two months, three months, one year, two years, or some other desired amount of time to obtain a meaningful sample size. In some embodiments, the predetermined period of time may begin with the first detected international call that may be indicative of when the second party established residence in a new country of origin for the international call. In some embodiments, the predetermined period of time may correspond to a probationary employment period of the second party, in accordance with employment laws of the country from which the second party calls. In addition, the total duration of incoming international calls from the second party to the potential borrower may be summed for the given periods of time. To determine the amount spend by the second party to the potential borrower, an international call rate applicable to the second party for the international calls to the location of the potential borrower may be determined. The international call rate may for calls between the two locations may be published in an online database, stored in a database (e.g., lookup table) at the service provider or lender, or otherwise available from one or more sources.

Thus, determining the amount spent by the second party to speak with the potential borrower may include determining an international call rate for the second party and a duration of telephone calls from the second party to the potential borrower, as shown in equation 3 below:

S₁=R×D (3),

where S₁ is the amount spent, R is the international call rate, and D is the duration of the international call. For non-duration based communications (e.g., SMS messages) in the call data, the amount spent by the second party may include determining the international message rate for the second party and the number of messages sent from the second party to the potential borrower:

S₂=R×M (4),

where S₂ is the amount spent, R is the international call rate, and D is the duration of the international call. In some embodiments, the combination of both duration-based communications and non-duration based communications may be considered by the system such that the total amount spent S_{T} may be used as the sum of both the duration-based calls and non-duration based communications.

At operation 506, the elasticity of international calls from the second party to the potential borrower may be determined as defined above in equation 1 and/or equation 2. As discussed above, an elasticity of the duration of such international calls may be identified with a change in the international call rate. In some embodiments, an elasticity equal to about unity (i.e., about 1.0) means that the international caller spends about the same amount of money to communicate with the international caller regardless of the international call rate. On the other hand, an elasticity that deviates from unity may be an indication that the change in the international call rate has a substantially negligible effect on a duration of international calls or number of messages sent to the potential borrower. A positive elasticity indicates that the international caller is not sensitive to changes in prices and hence has stronger financial strength and while a negative elasticity indicates that he is sensitive to price changes (calls and/or messages less) and means he has weaker financial strength.

At operation 508, a distribution of international calls with the second party may be analyzed along with other trends in international call patterns. For example, trends may be identified such as a consistency of an amount spent by the second party to speak with the potential borrower, a consistency of a duration for international calls from the international caller to the potential borrower, a distribution of call patterns (e.g., a frequency of calls) from the second party to the potential borrower, etc. The distribution of call patterns may include a number of times the second party calls the potential borrower within a given period of time (e.g., daily, weekly, biweekly, monthly, etc.). Thus, it may be determined whether the second party calls the potential borrower sporadically or if there is a pattern in the calls from the second party.

At operation 510, a strength of a relationship between the international caller and the potential borrower may be estimated. In some embodiments, the strength of the relationship may be based, in part, on the closeness of the relation (e.g., spouse, sibling, parent). The relationship may be verified by the lender but also supplemented by the analysis performed during operation 510 in monitoring call volume, distribution, patterns, and other trends identified when analyzing the call data. In some embodiments, the strength of the relationship may be estimated based on the call data, such as by analyzing the duration of calls from the second party to the potential borrower, the consistency with which the second party calls the potential borrower, and frequency of calls. In some embodiments, the strength of the relationship may be determined based on the percentage of money spent on communicating with a particular number compared with all international calls. For example, it may be monitored whether the international caller is calling more than one number to his home country and the distribution of his calls (whether volume of calls or by amount spent) to the different numbers being called. Calls corresponding to more call volume (or spending) could indicate a stronger relationship (e.g., he calls his wife more than he calls cousins). In other words, the more frequently and the greater amount of money the second party spends in speaking with the potential borrower, the greater the estimated strength of the relationship. In some embodiments, the strength of the relationship may be determined by monitoring calls from the international caller made on holidays or other special days (e.g., birthday) each year. If the international caller consistently calls the potential borrower on a holiday or other special day, the stronger the relationship may be (e.g., direct family member). The stronger the established relationship and the fact that the international caller is providing financial support (in the from of money remittance), the stronger the creditworthiness of the party that is receiving the call.

At operation 512, information regarding the labor laws affecting the second party may be received to be used in the determination of creditworthiness of the potential borrower. For example, it may be determined if the second party is within a probationary period of employment, has a defined contractual tem, is an at-will employee, is beyond a legal period of time for remaining in the country, etc. In some embodiments, the maximum term offered for the loan may be only post the probationary period or be limited to the length remaining term of the international caller employment contract.

At operation 514, the creditworthiness of the potential borrower may be determined based on analyzing the financial strength of the international caller and the strength of the relationship between the international caller and the potential borrower. In some embodiments, the incoming international calls with the second party may be analyzed to determine amount of money spent by the second party to place the international calls, particularly those to the potential borrower. A credit score may be calculated as an indication of the financial strength of the second party who may be financially supporting the potential borrower. The credit score may be influenced by one or more of the factors discussed above. For example, the credit score of the potential borrower may increase as the amount spent by the second party on the international calls with the potential borrower increases (operation 504). In some embodiments, a credit score of the potential borrower may decrease when the elasticity approaches unity and may increase for elasticity values that deviate from unity (operation 506).

In some embodiments, the credit score of the potential borrower may be increased as certain distribution and trends of the incoming international calls are identified (operation 508). For example, the credit score of the potential borrower may increase as a number of times the second party calls the potential borrower increases. As a non-limiting example, a credit score of a potential borrower may be higher when the second party calls the potential borrower daily compared to when the second party calls the potential borrower weekly or monthly. A credit score of the potential borrower may also be increased when the second party has spent a predetermined amount to speak with the potential borrower for the predetermined period of time. In other words, the credit score of the potential borrower may increase as a length of time over which the second party has spent more than a predetermined amount to speak with the potential borrower increases. In some embodiments, a credit score of the potential borrower increases as a number of consecutive months an amount spent by the second party to speak with the first party exceeds a predetermined amount.

In some embodiments, the credit score may increase when the strength of the relationship between the potential borrower and the second party is determined to be relatively strong (operation 510). For example, the credit score may be higher if the relationship of the potential borrower and the second party is an immediate family member (e.g., spouse, parent, sibling, etc.) as opposed to a more distant relationship (e.g., cousin, friend, etc.). The strength of the relationship may be determined based on the call history as well, such as by analyzing call duration, frequency, returning calls quickly, etc. An increased strength of relationship may correlate to a willingness of the second party to remit money to the potential borrower.

In some embodiments, the credit score may increase when the second party is complying with labor laws of their respective country and have a sufficient amount of time left for their employment period (operation 512). In some embodiments, the credit score of the potential borrower increases when the second party is beyond the probationary period of employment. The credit score of the potential borrower may also increase if the labor laws provide for contractual employment rather than employment at will, with an increasing credit score as a term of the employment contract increases. For example, a credit score of a potential borrower may be increased more when the second party has a two year employment contract than when the second party has a one year employment contract. The credit score of the potential borrower may be increased when the second party is closer to the beginning of the term of the employment contract as opposed toward the end of the employment term.

Thus, the creditworthiness of the potential borrower may be based on the amount of money spent by the second party to call the potential borrower as well as other factors. It is contemplated that, at least in some instances, a decision to extend credit to the potential borrower is based on whether the amount of money spent by the second party on international calls exceeds a percentage of the microloan requested by the potential borrower. By way of non-limiting example, if the second party spends more on international calls than, for example, about 1%, more than about 2%, more than about 5%, or even more than about 10% of the amount requested by the potential borrower, the decision to extend credit to the potential borrower may be made. For example, depending on labor laws and the minimum wage, an international caller may spend about 4-8% of his disposable income on calls. As such, the international caller spending can be used to derive his disposable income, and can help to determine the maximum amount to be lent to the potential borrower. Additionally, the more concentrated his spending toward a single person to stronger the relationship to the potential borrower.

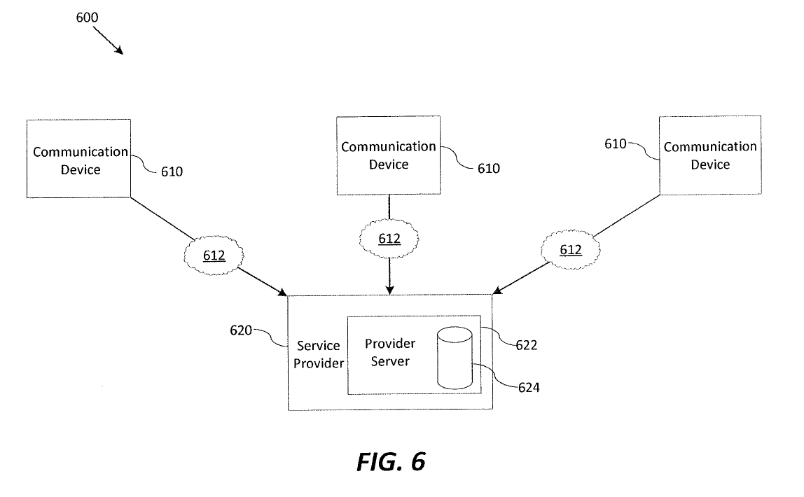

FIG. 6 is a simplified block diagram of a system 600 configured to facilitate determination of a credit score of a potential borrower that is a customer of a service provider 620. As discussed above, the lender and the service provider may be the same entity. The system 600 may include, for example, one or more communication devices 610, each operably coupled to the service provider 620 via a network 612. The service provider 620 may be substantially the same as the service provider 120 described above with reference to FIG. 1 with the exception that the service provider 620 may extend credit to its customers using its own customer data for determining the creditworthiness (e.g., by calculating a proprietary credit score) of a customer in obtaining a loan using the methods and factors discussed above. For example, the service provider 620 may use its own data to extend its own customers a line of credit for various purposes, including permitting customers to borrow funds for using telecommunication services of the service provider 620, including permitting overdue balances or negative balances depending on the type of plan before discontinuing the telecommunication services.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

What is claimed is:

1. A method of determining a creditworthiness of a potential borrower, the method comprising:
receiving call data including incoming international calls received from an international caller to a potential borrower, wherein the potential borrower is determined to specifically rely upon the international caller for at least a portion of the potential borrower's income;
determining, by a processor, a financial strength of the international caller based, at least in part, on analyzing an amount spent for international calls from the call data;
determining, by the processor, a relationship strength between the international caller and the potential borrower; and
determining, by the processor, creditworthiness of the potential borrower based, at least in part, on the determined financial strength of the international caller, and the determined relationship strength between the international caller and the potential borrower.

2. The method of claim 1, wherein determining the financial strength of the international caller includes multiplying a duration of incoming international voice calls from the international caller to the potential borrower with an international voice calling rate for the international caller.

3. The method of claim 1, wherein determining the financial strength of the international caller includes multiplying a number of incoming international text messages from the international caller to the potential borrower with an international text messaging rate for the international caller.

4. The method of claim 1, wherein determining the financial strength of the international caller includes adding an amount spent on international text messages and international voice calls by the international caller.

5. The method of claim 1, further comprising deter ruining, by the processor, that the international caller has established a new residence based on detecting a first call in the call data being placed from a new country of origin.

6. The method of claim 1, wherein determining creditworthiness of the potential borrower further comprises verifying labor laws applicable to the international caller.

7. The method of claim 6, wherein verifying labor laws applicable to the international caller comprises verifying whether the international caller has been employed for longer than a probationary period permitted by the labor laws of a country or by a contractual relationship of employment.

8. The method of claim 1, wherein determining creditworthiness of the potential borrower further comprises determining, from the call data, a change in the amount spent by the international caller to communicate with the potential borrower relative to a change in the international call rate.

9. The method of claim 1, wherein determining a relationship strength between the international caller and the potential borrower includes determining a call pattern from the call data that is based on at least one of a volume of international calls from the international caller to the potential borrower, a frequency of international calls from the international caller to the potential borrower, or a combination thereof.

10. A system for determining creditworthiness of a potential borrower who is a user of a communication device, the system comprising:
a communication device associated with a potential borrower or an international caller who is a customer of a telecommunications service provider; and
a first server associated with at least one of the telecommunications service provider or a lender, the first server comprising a first database including call data associated with the communication device from the telecommunications service provider, and a processor configured to determine creditworthiness of the potential borrower based on at least an amount of money spent by the international caller to communicate with the potential borrower based on an analysis of the call data, wherein the potential borrower is verified to be at least partially financially dependent on the international caller.

11. The system of claim 10, wherein the processor is further configured to determine a credit score for the potential borrower based on an amount of money spent by the international caller for international calls with the potential borrower over a predetermined period of time.

12. The system of claim 11, wherein the processor is further configured to determine the credit score based on labor laws of a country from which calls from the international caller originate.

13. The system of claim 11, wherein the processor is further configured to determine the credit score based on a frequency of incoming calls to the potential borrower from the international caller.

14. The system of claim 11, wherein the processor is further configured to determine the credit score based on an elasticity of a duration or a number of the international calls from the international caller relative to changes in an international call rate.

15. The system of claim 10, wherein the first server is associated with the telecommunications service provider and is configured to transmit at least one of the call data or a credit score to a second server associated with the lender.

16. The system of claim 10, wherein the first server is associated with the lender and is configured to receive the call data from a second server associated with the telecommunications service provider.

17. The system of claim 10, wherein the first server the telecommunications service provider and the lender are a single entity such that the telecommunications service provider is configured to extend credit to the potential borrower based on the determined creditworthiness of the potential borrower.

18. A server associated with a lender and configured to determine a credit score of a potential borrower, the server comprising:
communication elements configured to communicate with a provider server associated with a telecommunications service provider;
a lender database stored in memory and configured to store at least one of call data or financial information received for the potential borrower from the provider server; and
a processor operably coupled with the memory, the processor configured to:
determine an amount spent by an international caller to communicate with the potential borrower based on incoming international calls to the potential borrower and an international call rate for the international caller; and
determine creditworthiness of the potential borrower based on the amount spent by the international caller over a predetermined period of time.

19. The server of claim 18, wherein the processor is configured to further determine creditworthiness of the potential borrower based on a determined elasticity of international calls from the international caller to the potential borrower responsive to a change in the international call rate.

20. The server of claim 18, wherein the incoming international calls include incoming voice calls and a corresponding international voice calling rate, incoming text messages and a corresponding international text messaging rate, or a combination thereof.
